(19) United States
(12) Patent Application Publication
(10) Pub. No.: US 2017/0228448 A1
(43) Pub. Date: Aug. 10, 2017

(54) METHOD AND APPARATUS FOR ASSOCIATION RULES WITH GRAPH PATTERNS

(71) Applicant: Futurewei Technologies, Inc., Plano, TX (US)

(72) Inventors: Wenfei Fan, Wayne, PA (US); Xin Wang, Chengdu (CN); Yinghui Wu, Pullman, WA (US); Jingbo Xu, Edinburgh (GB)

(21) Appl. No.: 15/018,294

(22) Filed: Feb. 8, 2016

(51) Int. Cl. G06F 17/30; G06N 5/04

(52) U.S. Cl. CPC G06F 17/30572; G06F 17/30958; G06N 5/047

(57) ABSTRACT

Graph pattern association rules (GPARs) are proposed for social media marketing. Extending association rules for item-sets, GPARs help discover regularities between entities in social graphs, and identify potential customers by exploring social influence. The problem of discovering top-k diversified GPARs is NP-hard. A parallel algorithm is thus disclosed with accuracy bound. A parallel scalable algorithm is further disclosed that guarantees a polynomial speedup over sequential algorithms with the increase of processors.

### BACKGROUND

In commercial enterprises, a wide variety of business decisions need to be made on a regular basis. In an example of a store stocking a large collection of items, management needs to decide what to put on sale, how to design coupons, how to place merchandise on shelves in order to maximize the profit, etc. Analysis of past transaction data stored in data sets is a commonly used approach in order to improve the quality of such decisions. Transaction data is mined to obtain information that can be used in future decisions. However, the mining of data from these data sets has proved difficult. One method of mining data from data sets is through the use of association rules, which in general are rules used to discover interesting relations between variables in large data sets.

Association rules have been well studied for discovering regularities between items in relational data sets, for example in promotional pricing and product placements. There have also been recent interests in studying associations between entities in social networks. Such associations are useful in social media marketing. Prior work on association rules for social networks and resource description framework (RDF) knowledge bases resorts to mining conventional rules and Horn rules (as conjunctive binary predicates) over tuples with extracted attributes from social graphs. However, such conventional work does not exploit graph patterns.

There is a need for efficiently and accurately identifying graph pattern association rules (GPARs) in social media marketing, community structure analysis, social recommendation, knowledge extraction and link prediction. Such rules, however, depart from association rules for item sets, and introduce several challenges. These challenges include: (1) conventional support and confidence metrics no longer work for GPARs; (2) mining algorithms for traditional rules and frequent graph patterns cannot be used to discover practical diversified GPARs; and (3) a major application of GPARs is to identify potential customers in social graphs. This is costly, in that graph pattern matching by subgraph isomorphism is intractable. Worse still, real-life social graphs are often big, e.g., Facebook has 13.1 billion nodes and 1 trillion links.

### SUMMARY

In one embodiment, the present technology relates to a method of identifying graph pattern association rules (GPARs) having a confidence above a predetermined threshold in a social network, the graph including a plurality of designated nodes and a plurality of association edges between the designated nodes, comprising: identifying a first data element that corresponds to a first node of interest; identifying at least a second data element that is a common data element to the first node of interest and to a second node of interest; identifying a first subgraph including the first node of interest and a second subgraph including the second node of interest, wherein the first and second subgraphs include the at least second data element identifying relationships among the first and the second nodes of interest, wherein the first and second subgraphs specify conditions as topological constraints represented by one or more edges formed from the relationships among the first and second nodes of interest; determining one or more graph pattern association rules (GPARs) for the first and second subgraphs; and using the first and second nodes of interest and the GPARs to identify one or more consequents among the second node of interest and the data elements.

In another embodiment, the present technology relates to a method of parallel mining of a set M of graph pattern association rules in a graph of a social network, the graph including a plurality of nodes and a plurality of association edges between nodes, the method comprising: dividing the graph into a plurality of fragments F; using a plurality of processors comprising a coordinator processor and a plurality of worker processors, processing each fragment F in parallel in each of the plurality of worker processors to identify candidate graph pattern association rules for the set M a candidate graph pattern association rule, R(x, y), being defined as Q(x, y) [symbol] q(x, y), where Q(x, y) is a graph pattern in which x and y are two designated nodes, and q(x, y) is an edge labeled q from x to y, on which the same search conditions as in Q are imposed; verifying candidate graph pattern association rules as having at least a predefined confidence threshold; and transmitting the verified candidate graph pattern association rules to the coordinator processor to update the set M.

In a further embodiment, the present technology relates to a system for identifying entities in a graph of a social network, the graph including a plurality of nodes and a plurality of association edges between nodes, graph pattern association rules, R(x, y), being defined for the graph, R(x, y) being defined as Q(x, y) [symbol] q(x, y), where Q(x, y) is a graph pattern in which x and y are two designated nodes, and q(x, y) is an edge labeled q from x to y, on which the same search conditions as in Q are imposed, the system comprising: a plurality of processors, the plurality of processors comprising a coordinator processor and a plurality of worker processors, the plurality of processors configured to: divide the graph into a plurality of fragments Fᵢ; process each fragment Fᵢ in parallel in each of the plurality of worker processors Sᵢ to identify local matches in Fᵢ; assemble the local matches Fᵢ from the plurality of worker processors Sᵢ into a match set; process the each fragment Fi in parallel in each of the plurality of worker processors Si to determine confidence value, conf(R, G), for each of the plurality of graph pattern association rules, where the confidence value defines how likely q(x, y) holds when x and y satisfy the constraints of Q(x, y) for each local fragment Fi; remove local matches from the match set where the local matches have a graph pattern association rule with a confidence value less than a predefined threshold; and output the graph pattern association rules and matches of the graph pattern association rules that are not removed in said step of remove local matches from the match set where the local matches have a graph pattern association rule with a confidence value less than a predefined threshold.

In a further embodiment, the present technology relates to a non-transitory computer-readable medium storing computer instructions for parallel mining of a set M of graph pattern association rules in a graph of a social network, the graph including a plurality of nodes and a plurality of association edges between nodes, that when executed by one or more processors, cause the one or more processors to perform the steps of: identifying a first data element that corresponds to a first node of interest; identifying at least a second data element that is a common data element to the first node of interest and to a second node of interest; identifying a first subgraph including the first node of interest and a second subgraph including the second node of interest, wherein the first and second subgraphs include the at least second data element identifying relationships among the first and the second nodes of interest, wherein the first and second subgraphs specify conditions as topological constraints represented by one or more edges formed from the relationships among the first and second nodes of interest; determining one or more graph pattern association rules (GPARs) for the first and second subgraphs; and using the first and second nodes of interest and the GPARs to identify one or more consequents among the second node of interest and the data elements, wherein the one or more consequents include a consequent between the second node of interest and the first data element.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIGS. 1A and 1B are illustrated subgraphs including nodes, data elements and edges between the nodes and data elements.

FIG. 2 is a flowchart illustrating how the likes, actions, or such of one person within a graph can be used to determine and predict future actions by other persons within the graph.

FIG. 3 is a flowchart showing a method of determining and using GPARs in a graph.

FIGS. 4-10 are social graphs for illustrating graph pattern association rules according to different embodiments of the present technology.

FIG. 11 is a flowchart for mining graph pattern association rules according to embodiments of the present technology.

FIG. 12 is a flowchart showing further detail of step 208 of FIG. 11.

FIG. 13 is a flowchart for identifying entities using graph pattern association rules.

FIG. 14 is a block diagram of an example computing environment for implementing a power management method and other aspects of the present technology.

### DETAILED DESCRIPTION

The present technology will now be explained with reference the figures which in general relate to graph pattern association rules (GPARs) used, for example, in social media marketing. GPARs differ from conventional rules for item sets in both syntax and semantics. A GPAR defines its antecedent as a graph pattern, which specifies associations between entities in a social graph, and explores social links, influence and recommendations. It enforces conditions via both value bindings and topological constraints by subgraph isomorphism.

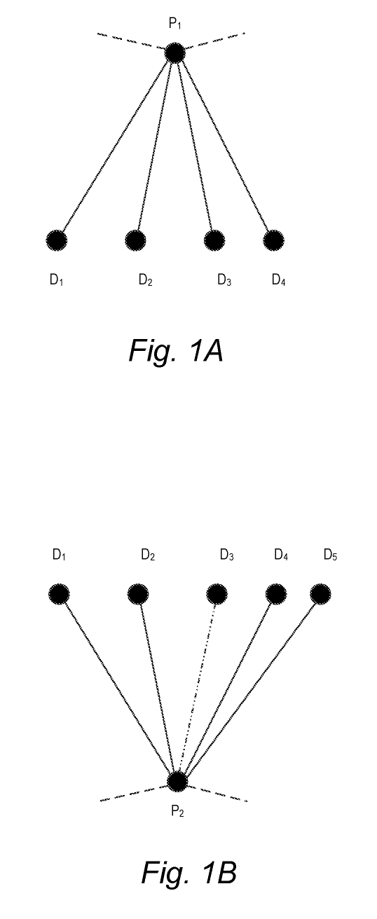

Graph patterns in general may be graphical mathematical structures used to model pairwise relations between objects. A graph in this context is made up of vertices, or nodes, which are connected by edges. Stated another way, a graph is an ordered pair G=(V, E) comprising a set V of vertices or nodes together with a set E of edges between the nodes. FIGS. 1A and 1B show a first node of interest P1 and a second node of interest P2. The first and second nodes of interest P1 and P2 can represent persons in a social network, for example. The first and second nodes of interest P1 and P2 in FIGS. 1A and 1B may be represented by subgraphs, as shown, but are part of a larger graph, which is not shown for simplicity. Complete graphs are shown and explained hereafter.

The first node P1 and/or the second node P2 are connected to nodes D1-D5 by edges. Nodes D1-D5 are data elements describing some object, feature, state or place of interest to P1 and/or P2. For example, the data elements can represent physical locations, such as a nation, city, region, and so forth. The data elements can represent stores, products, or brands, and so forth. The data elements can represent a location lived in or visited by the corresponding person of the node of interest. The data elements can be used to determine common preferences, experiences, travels, visits, and so forth between the persons represented by the nodes of interest. As a consequence, comparison of various subgraphs can be used to determine and predict future actions by persons represented in a graph such as a social network. In this example, the first node of interest P1 is connected to data elements D1-D4, while the second node of interest P2 is connected to data elements D1-D2 and D4-D5. Thus, as a consequence, comparison of the subgraphs of nodes P1 and P2 can be used to determine and predict future actions by P1 and/or P2.

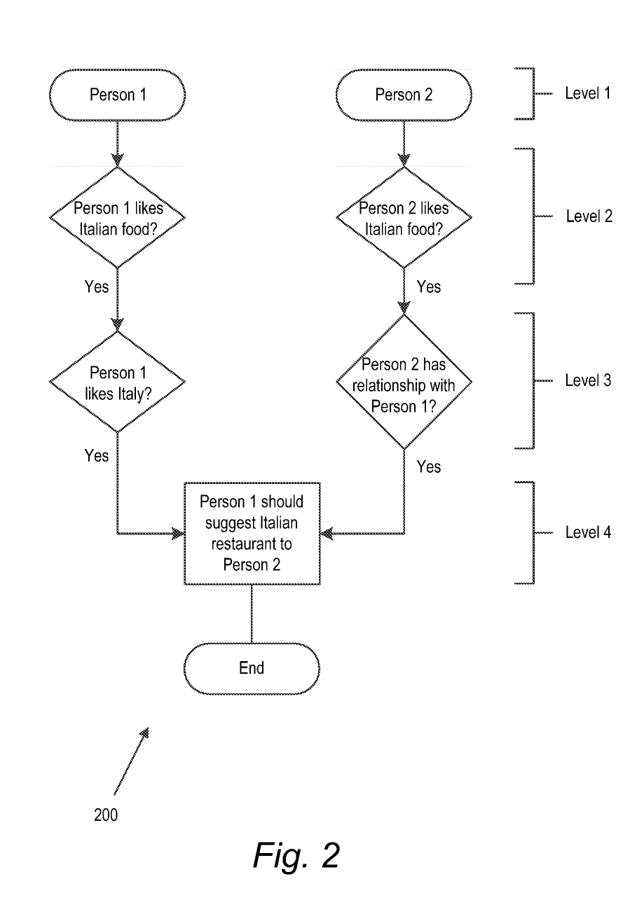

FIG. 2 is a flowchart 200 that shows how the likes, actions, or such of one person within a graph can be used to determine and predict future actions by other persons within the graph. Here, at level 1, Person 1 and Person 2 exist within the same graph. At level 2, it can be determined that Person 1 likes Italian food and Person 2 likes Italian food. At level 3, it can be determined that Person 1 likes Italy, which can be represented in a graph by various types of informational relationships, such as through travel to Italy, purchase of items related to Italy, and so forth. Also at level 3, it is determined that Person 2 has a relationship with Person 1, such as being friends, family, co-workers, neighbors, or having some other manner of relationship. At level 4, based on the known information, it can be predicted that Person 1 might recommend a new Italian restaurant to Person 2. Therefore, Person 2 may be determined to be a candidate for advertising, a special offer, or the like from the new Italian restaurant, based on the similar likes and relationship between Person 1 and Person 2, and based on analysis of their two subgraphs, using GPARs as explained below.

Referring again to FIGS. 1A and 1B, by comparing the two subgraphs of P1 and P2, such as through generation of GPARs, a connection/graph edge or edges can be inferred between P2 and D3 in FIG. 1B, similar to the connection between P1 and D3 in FIG. 1A.

In this example, the first node of interest P1 includes a relationship/edge with a first data element D3. The first node of interest P1 further includes relationships/edges with second data elements D1-D2 and D4. In this example, the second node of interest P2 does not include a relationship/edge with the first data element D3. The second node of interest P2 shares common relationships/edges with the second data elements D1-D2 and D4. The second node of interest P2 in this example further includes a relationship/edge with a third data element D5 that is not in common with the first node of interest P1.

Using GPARs as explained below, a consequent can be determined, with the consequent in this example including a relationship being inferred or predicted between the second node of interest P2 and the first data element D3. This is shown by a dashed line in FIG. 1B. It should be understood that multiple consequents can be determined in this step, and only one consequent is shown and discussed for simplicity.

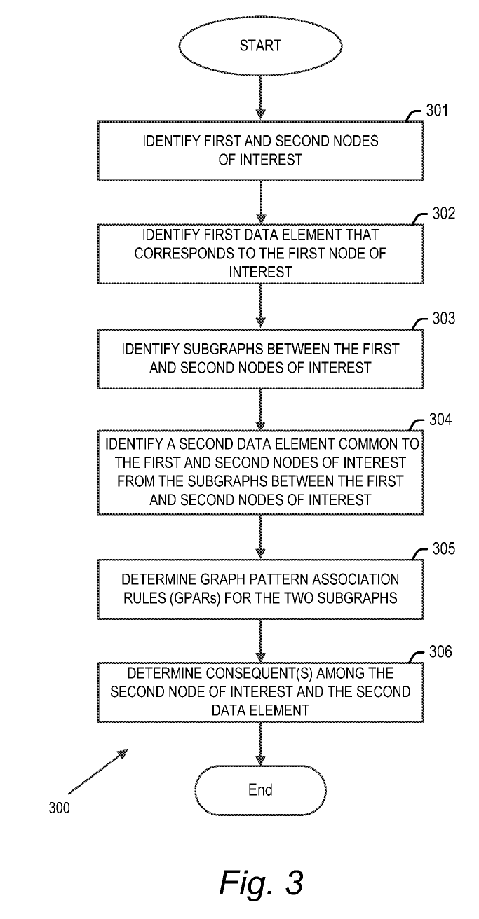

FIG. 3 is a flowchart 300 of a method of determining and using GPARs in a graph. The graph in some examples comprises a social network. In a step 301, first and second nodes of interest are identified. As noted above, these nodes of interest may be people, but nodes need not be people in further embodiments. It is possible that a graph may include more than two nodes of interest in further embodiments explained below. In step 302, a first data element is identified that corresponds to the first node of interest. In a step 303, subgraphs are identified between the first and second nodes of interest. For example, the subgraph for the first node of interest may include the first node of interest and data elements connected to the first node of interest by edges. The subgraph for the second node of interest may include the second node of interest and data elements connected to the second node of interest by edges. The subgraphs of the first and second nodes of interest may share one or more data elements in common. In step 304, a second data element is identified that is common to both the first and second nodes of interest. There may be more than one second data element in embodiments.

In step 305, GPARs are determined for the two or more subgraphs. GPARs are explained below, but in general operate to identify relationships between nodes of interest and data items inferred from other nodes of interest and the data items. In step 306, using the GPARs determined in step 305, the consequent relationship between the second node of interest and the second data element.

Topological support and confidence metrics are defined for GPARs as explained below. Support is defined in terms of distinct “potential customers,” and a confidence metric is defined for GPARs to incorporate a local closed world assumption. This enables the present technology to cope with incomplete social graphs, and to identify interesting GPARs with correlated antecedent and consequent. Generally, in logic systems, the consequent is the second half of a hypothetical proposition while the antecedent precedes and may be the cause of the consequent.

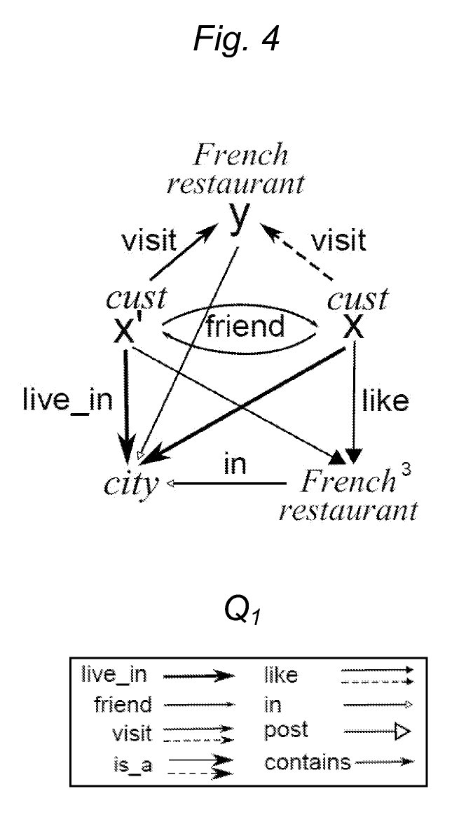

In accordance with the present technology, a graph is defined as G=(V, E, L), where (1) V is a finite set of nodes; (2) E⊂V×V is a set of edges, in which (υ, υ′) denotes an edge from node υ to υ′; (3) each node υ in V carries L(υ), indicating its label or content as found in social networks and property graphs. Each edge e also carries L(e), indicating its label or content as found in social networks and property graphs. FIGS. 4-9 show examples of graphs G having graph patterns Q.

A pattern query is a graph (Vₚ, Eₚ, ƒ, C), in which Vₚ and Eₚ are the set of pattern nodes and edges, respectively. Each node uₚ in Vₚ has a label ƒ(uₚ) specifying a search condition, e.g., city. Each edge eₚ in Eₚ also as a label ƒ(eₚ) specifying a search condition, e.g., lives in, likes, etc. For succinct representation, a node uₚ can be labeled with an integer C(uₚ)=k, indicating k copies of uₚ with the same label and associated links in the common neighborhood.

Graph pattern matching may be accomplished using two definitions of subgraphs. (1) A graph G′=(V′, E′, L′) is a subgraph of G=(V, E, L), denoted by G′⊂G, if V′⊂V, E′⊂E, and moreover, for each edge eεE′, L′ (e)=L(e), and for each υεV′, L′ (υ)=L(υ). (2) G′ is a subgraph induced by a set V′ of nodes if G′⊂G and E′ consists of all those edges in G whose endpoints are both in V′.

Subgraph isomorphism may be adopted for pattern matching. A match of pattern Q in graph G is a bijective function h from the nodes of Q to the nodes of a subgraph G′ of G such that (a) for each node uεVₚ, ƒ(u)=L(h(u)), and (b (u, u′) is an edge in Q if and only if (h(u), h(u′)) is an edge in G′, and ƒ(u, u′)=L(h(u), h(u′). It can be said that G′ matches Q.

The set of all matches of Q in G may be denoted by Q(G). For each pattern node u, Q(u, G) may be used to denote the set of all matches of u in Q(G), i.e., Q(u, G) consists of nodes υ in G such that there exists a function h under which a subgraph G′εQ(G) is isomorphic to Q, υεG′ and h(u)=υ.

FIG. 4 shows a social graph G₁ having a graph pattern Q₁ including a defined association rule for identifying potential customers for a new French restaurant. The social graph G₁ includes the following conditions, or antecedents: (a) x and x′ are friends living in the same city c, (b) there are at least 3 French restaurants in c that x and x′ both like, and (c) x′ visits a newly opened French restaurant y in c. Given (a), (b) and (c), then a result, or consequent, may be shown with some degree of confidence. Here, the consequent is that x may also visit newly opened French restaurant y.

The antecedent of the rule can be represented as a graph pattern Q₁ (with solid edges) shown in FIG. 4, and the consequent is indicated by a dotted edge visit(x, y). A succinct presentation of Q₁ associates integer 3 with “French Restaurant” to indicate its 3 copies. As opposed to conventional association rules, Q₁ specifies conditions as topological constraints: edges between customers (the friend relation), customers and restaurants (like, visit), city and restaurants (in), and between city and customers (live in). In the social graph G₁, for x and y satisfying the antecedent Q₁ via graph pattern matching, new French restaurant y can be recommended to x.

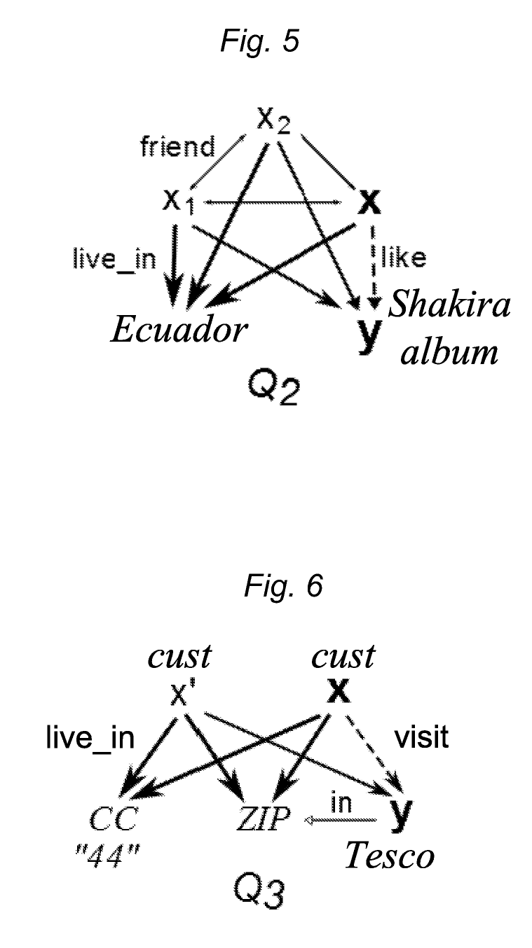

As opposed to rules for item sets, association rules for social graphs may target social groups with multiple entities. For example, FIG. 5 shows an association rule in the social graph G₂ having graph pattern Q₂. In general, both graphs G and graph patterns Q are graphs. A graph pattern Q has nodes and edges constructed in a similar way to a social graph G. However, semantically, they are different. A graph pattern Q is question; it contains variables, specified by search conditions, and a goal is to find matches for the variables of the graph pattern Q in the social graph G. A social graph G contains data as a complete statement and does not contain variables.

The association rule shown by the social graph of FIG. 5 is: If (a) x, x₁ and x₂ are friends, (b) they all live in Ecuador, and (c) if x₁, x₂ both like Shakira's album y (a Colombian singer), then x may also like y. In FIG. 5, a graph pattern Q₂ (excluding the dotted edge) specifies conditions for (x, y) as antecedent, and dotted edge like (x, y) indicates its consequent. The association rule can be used to identify potential customers x of y, characterized by a social group of three members.

Association rules with graph patterns conveniently extend data dependencies such as conditional functional dependencies (CFDs) in the context of social networks. FIG. 6 shows an illustrative association rule in the graph G₃ having graph pattern Q₃. In FIG. 6, the association rule is: If the addresses of x and x′ have the same country code “44” and same zip code, and if x′ shops at a Tesco store y with the same zip, then x may also shop at y. The association rule of FIG. 6 embeds a corresponding CFD in its graph G₃, stating that if x and x′ live in the UK with the same zip code, then they live on the same street. The rule is valid in the UK where zip code determines street.

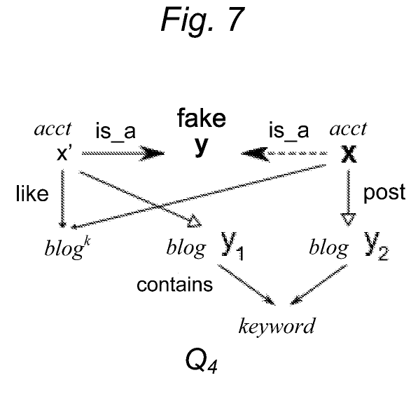

Applications of association rules are not limited to marketing activities. They also help detect scams. FIG. 7 illustrates an association rule in graph G₄ having graph pattern Q₄ used to identify fake accounts. The association rule is: If (a) account x′ is confirmed fake, (b) both x and x′ like blogs P₁, . . . , Pₖ, (c) x posts blog y₁, (d) x′ posts y₂, and (e) if y₁ and y₂ contain the same particular content (keyword), then x is likely a fake account. As depicted in FIG. 7, its antecedent is given by graph pattern Q₄ (excluding the dotted edge), and its consequent is the dotted edge ‘is_a(x, fake)’. In the social graph G₄, the rule is to identify suspects for fake accounts, i.e., accounts x that satisfy the structural constraints of pattern Q₄.

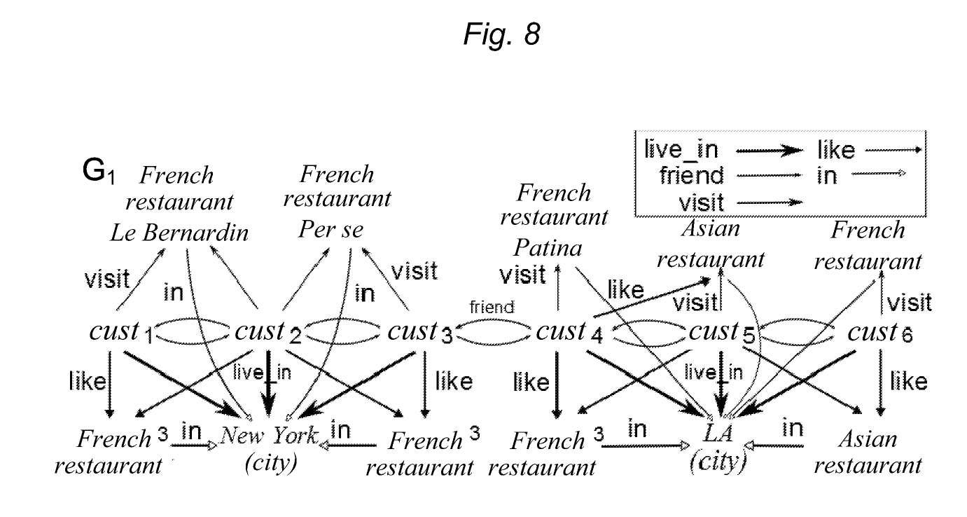

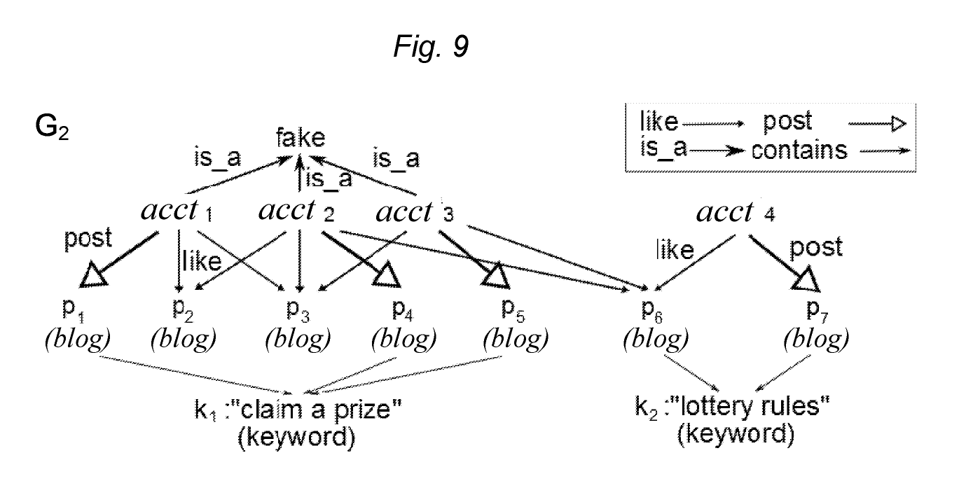

FIGS. 8 and 9 show two graphs G₅ and G₆ having graph patterns Q₅ and Q₆, respectively. Graph G₅ depicts a restaurant recommendation network. For instance, cust₁ and cust₂ (labeled cust) live in New York; they share common interests in 3 French restaurants (marked with superscript 3 for simplicity); and they both visit a newly opened French restaurant “Le Bernadin” in New York. (2) Graph G₆ shows activities of social accounts. It contains (a) accounts acct₁, . . . , acct₄ (labeled acct), (b) blogs p₁, . . . , p₇; and (c) edges from accounts to blogs. For example, edge post(acct₁, p₁) means that account acct₁ posts blog p₁, which contains keyword w₁ “claim a prize”.

For pattern Q₅ of FIG. 8 (and Q₁ of FIG. 4), a match in Q₅(G) is x [symbol] cust₁, x′ [symbol] cust₂, city [symbol] New York, y [symbol] Le Bernardin, and French restaurant³ to 3 French restaurants. Here Q₅(x, G₅) includes cust₁-cust₃ and cust₅.

A pattern Q′=(V′p, E′p, ƒ′, C′) is said to be subsumed by another pattern Q=(Vₚ, Eₚ, ƒ, C), denoted by Q′ [symbol] Q, if (V′ₚ, E′ₚ) is a subgraph of (Vₚ, Eₚ), and functions ƒ′ and C′ are restrictions of ƒ and C in V, respectively. If Q′ [symbol] Q, then for any graph G′ that matches Q, there exists a subgraph G″ of G′ such that G″ matches Q′.

The following notations may be used. (1) For a pattern Q and a node x in Q, the radius of Q at x, denoted by r(Q, x), is the longest distance from x to all nodes in Q when Q is treated as an undirected graph. (2) Pattern Q is connected if for each pair of nodes in Q, there exists an undirected path in Q between them. (3) For a node υₓ in a graph G and a positive integer r, Nᵣ(υₓ) denotes the set of all nodes in G within radius r of υₓ. (4) The size |G| of G is |V|+|E|, the number of nodes and edges in G. (5) Node υ′ is a descendant of υ if there is a directed path from υ to υ′ in G.

Using the above framework, graph pattern association rules, or GPARs, may be defined. A GPAR R(x, y) is defined as Q(x, y) [symbol] q(x, y), where Q(x, y) is a graph pattern in which x and y are two designated nodes, and q(x, y) is an edge labeled q from x to y, on which the same search conditions as in Q are imposed. Q and q are referred to as the antecedent and consequent of R, respectively.

A rule may be formulated that for all nodes υₓ and υ_{y} in a (social) graph G, if there exists a match hεQ(G), such that h(x)=υₓ and h(y)=υ_{y} (i.e υuₓ and υ_{y}), match the designated nodes x and y in Q, respectively, then the consequent q(υuₓ, υ_{y}) will likely hold. Intuitively, υₓ is a potential customer of υ_{y}. R(x, y) may be modeled as a graph pattern P_{R}, by extending Q with a (dotted) edge q(x, y). Pattern P_{R} may be referred to as R when it is clear from the context. q(x, y) may be treated as pattern P_{q}, and q(x, G) as the set of matches of x in G by P_{q}. Practical and nontrivial GPARs may be considered by requiring that (1) P_{R} is connected; (2) Q is nonempty, i.e., it has at least one edge; and (3) q(x, y) does not appear in Q.

The association rule described above with respect to FIG. 4 may be expressed as a GPAR R₁(x, y): Q₁(x, y) [symbol] visit(x, y), where its antecedent is the pattern Q₁ shown in FIG. 4, and its consequent is visit(x, y). The GPAR can be depicted as the graph pattern of FIG. 4, by extending Q₁(x, y) with a dotted edge for visit(x, y).

The association rule described above with respect to FIG. 4 may be expressed as a GPAR R₄(x, y): Q₄(x, y) [symbol] is_a(x, y), where in Q₄, y=fake is a value binding. The GPAR is depicted as the pattern of FIG. 7. In is_a(x, y), the same search condition y=fake is imposed.

In embodiments, the consequent of GPAR may be defined with a single predicate q(x, y). Conditional functional dependencies can also be represented by GPARs (see Q₃ of FIG. 6).

Support and confidence may further be defined for GPARs. The support of a graph pattern Q in a graph G, denoted by supp(Q, G), indicates how often Q is applicable. As with association rules for item sets, the support measure should be anti-monotonic, i.e., for patterns Q and Q′, if Q′ [symbol] Q, then in any graph G, supp(Q′, G)≧supp(Q, G).

Supp(Q, G) may be defined as the number ∥Q(G)∥ of matches of Q in Q(G). However, this conventional notion is not anti-monotonic. For example, consider pattern Q′ with a single node labeled cust, and Q with a single edge like (cust, French restaurant). When posed on G₁, ∥Q(G)∥=18>∥Q′(G)∥=6 (since French restaurant³ denotes 3 nodes labeled French restaurant), although Q′ [symbol] Q.

To cope with this, support of the designated node x of Q may be defined as ∥Q(x, G)∥, i.e., the number of distinct matches of x in Q(G). The support of Q in G may be defined as

supp(Q,G)=∥Q(x,G)∥ (1)

One can verify that this support measure is anti-monotonic. For a GPAR R(x, y): Q(x, y) [symbol] q(x, y), supp(R, G) may be defined:

supp(R,G)=∥P_{R}(x,G)∥ (2)

by treating R as pattern P_{R}(x, y) with designated nodes x, y.

Referring again to FIG. 8, for GPAR R₅(x, y): Q₅(x, y) [symbol] visit(x, y) of graph G₅ of FIG. 8, (1) ∥Q₅(x, G₅)∥=4; hence supp(Q₅, G₅) is 4; and (2) supp(R₅, G₅)=∥P_{R5} (x, G₅)∥=3 where x has 3 matches cust₁-cust₃. Similarly, consider R₆(x, y): Q₄(x, y) [symbol] is_a(x, y) of FIG. 9, where y=fake. When k=2, supp(R₆, G₂)=supp(Q₆, G2)=∥Q₆(x, G₂)∥=3, with matches acct₁-acct₃ for the designated node x in Q₆.

Referring now to confidence, confidence may be used to find how likely q(x, y) holds when x and y satisfy the constraints of Q(x, y). The confidence of R(x, y) in G may be denoted as conf(R, G). In general, confidence is based in part on the number of pattern matching isomorphic subgraph association edges for the two or more designated nodes, where more pattern matching isomorphic subgraph association edges correlate to a higher confidence level. In embodiments, confidence of a GPAR may be defined as:

$$conf ( R , G ) = \frac{supp ( R , G )}{supp ( Q , G )} .$$

That is, every match x in Q but not in R is considered as negative example for R. However, the standard confidence is blind to the distinction between “negative” and “unknown”. This is particularly an overkill when G is incomplete.

Referring back to pattern Q₂ in FIG. 5, let Q₂(x, G) contain three matches v₁, v₂, v₃ of x₁, x₂, x₃ in a social graph G, all living in Ecuador, where (1) v₁ has an edge like to Shakira album, (2) v₂ has only a single edge like to MJ's album, and (3) v₃ has no edge of type like. Confidence treats v₂ and v₃ both as negative examples, with conf(R₂, G)=⅓. However, G may be incomplete: v₃ has not entered any albums she likes. Thus v₃ should be treated as “unknown”, not as a counterexample to R₂.

The closed world assumption may not hold for social networks. To distinguish “unknown” cases from true negative for GPAR mining in incomplete social networks, the local closed world assumption may be adopted, as commonly used in mining incomplete knowledge bases. The following notations may be used for local closed world assumption (LCWA), given a predicate q(x, y).

(1) supp(q, G)=∥P_{q}(x, G)∥, the number of matches of x;

(2) supp(q̅, G), the number of nodes u in G that (a) have the same label as x, (b) have at least one edge of type q, but (c) uε6 P_{q}(x, G); and

(3) supp(Q q̅, G), the number of nodes that satisfy conditions (a) to (c) of (2), and are also in Q(x, G).

Given an (incomplete) social network G and a predicate q(x, y), the local closed world assumption (LCWA) distinguishes the following three cases for a node u.

(1) “positive” case, if uεP_{q}(x, G);

(2) “negative” case, for every u counted in supp(q̅, G); and

(3) “unknown” case, for every u that satisfies the search condition of x but has no edge labeled as q.

That is, G is assumed “locally complete”. Therefore, G either gives all correct local information of u in connection with predicate q, or knows nothing about q at node u (hence unknown cases).

Based on LCWA, conf (R, G) may be defined by revising the Bayes Factor (BF) of association rules as described for example in S. Lallich, O. Teytaud, and E. Prudhomme, “Association rule interestingness: Measure and statistical validation,” In Quality measures in data mining, pages 251-275. 2007. This may be done as:

$$conf ( R , G ) = \frac{supp ( R , G ) * supp ( \overline{q , G} )}{supp ( Q \overline{q} , G ) * supp ( q , G )}$$

Intuitively, conf(R, G) measures the product of completeness and discriminant. A GPAR R(x, y) has a better completeness if, for more matches of x identified in Q(x, y) there are also matches of x in R(x, y), and is more discriminant if, for more matches of x in Q(x, y), there are less likely to be matches in Q q̅. In addition, BF-based conf(R, G) is better justified than conventional confidence. BF satisfies a set of principles for reasonable interestingness measures, including fixed under independence (conf(R, G)=1 if Q and q are statistically independent), fixed under incompatibility (conf(R, G)=0 if supp(R, G)=0), and mono-tonicity (increases monotonically with supp(R, G) when supp(q̅, G), supp(Q, G) and supp(q, G) are fixed). Thus, BF may be adapted by incorporating LCWA and topological support.

Referring to GPAR R₂ and Q₂(x, G) described above with respect to FIG. 5, under the LCWA, match v₁ accounts for “positive” for R₂, while v₂ and v₃ are “negative” and “unknown”, respectively. Assuming that G provides complete local information for v₂, then v₂ is a counter-example to people who live in Ecuador but do not like Shakira album; in contrast, G knows nothing about what albums v₃ likes.

It can be seen that supp(R₂, G)=1 (match v₁), supp(q̅, G)=1 (match v₂), supp(Q q̅, G)=1 (match v₂), and supp(q, G)=1 (match v₁). The BF-based confidence conf(R₂, G) is 1, larger than its conventional counterpart as the LCWA removes the impact of the unknown case v₃.

There are other alternatives to define support and confidence for GPARs. (1) Following minimum image-based support (B. Bringmann and S. Nijssen, “What is frequent in a single graph?” In PAKDD, 2008), supp(R, G) can be defined as the maximum number of matches for x in non-overlap matches (i.e., no shared nodes and edges) of R. However, this excludes potential customers from matches that share even a single node (e.g., only one of the three matches cust1-cust3 of FIG. 8 is counted), and thus underestimates the significance. (2) Similar to PCA confidence (L. A. Galárraga, C. Teflioudi, K. Hose, and F. Suchanek, “AMIE: association rule mining under incomplete evidence in ontological knowledge bases,” In WWW, 2013), conf(R, G) can be computed as

$$\frac{supp ( R , G )}{supp ( Q \overline{q} , G )}$$

under LUWA. However, this only considers the “coverage” of R instead of its interestingness in terms of completeness and discriminant.

Two trivial cases are noted when conf(R, G)=∞: (1) supp(Q q̅, G) is 0, which interprets R as a logic rule that holds on the entire G, i.e., “if v is in Q(x, G) then visa match in P_{q}(x, G) (hence P_{R}(x, G))”; and (2) supp(q, G)=0, which means that q(x, y) in R specifies no user in G; hence R should be discarded as uninteresting case. These two cases can be easily detected and distinguished in the GPAR discovery process.

The following section describes how to discover useful GPARs. GPARs for a particular event q(x, y) are of interest. However, this often generates an excessive number of rules, which often pertain to the same or similar people. This motivates the study of a diversified mining problem, to discover GPARs that are both interesting and diverse.

To formalize the problem, an objective function diff(,) is first defined to measure the difference of GPARs. Given two GPARs R₁ and R₂, diff(R₁, R₂) is defined as:

$$diff ( {R}_{1} , {R}_{2} ) = 1 - \frac{\vert {P}_{{R}_{1}} ( x , G ) ⋂ {P}_{{R}_{2}} ( x , G ) \vert}{\vert {P}_{{R}_{1}} ( x , G ) ⋃ {P}_{{R}_{2}} ( x , G ) \vert}$$

in terms of the Jaccard distance of their match set (as social groups). Such diversification has been adopted to battle against over-concentration in social recommender systems when the items recommended are too “homogeneous”. See for example, S. Amer-Yahia, L. V. Lakshmanan, S. Vassilvitskii, and C. Yu, “Battling predictability and overconcentration in recommender systems,” IEEE Data Eng. Bull., 32(4), 2009.

Given a set Lₖ of k GPARs that pertain to the same predicate q(x, y), the objective function F(Lₖ) may be defined again by following the practice of social recommender systems (as disclosed in S. Gollapudi and A. Sharma, “An axiomatic approach for result diversification,” In WWW, 2009):

$$( 1 - λ ) {\sum }_{{R}_{i} ∈ S} \frac{conf ( {R}_{i} )}{N} + \frac{2 λ}{k - 1} {\sum }_{{R}_{i} , {R}_{i} ∈ S , i < j} diff ( {R}_{i} , {R}_{j} )$$

This, known as max-sum diversification, aims to strike a balance between interestingness (measured by revised Bayes Factor) and diversity (by distance diff(,)) with a parameter λ controlled by users. Taking nontrivial GPARs (discussed above) with conf(R, G)ε[0, supp(R, G)*supp(q̅, G)], and normalize (1) the confidence metric with N=supp(q, G)*supp(q̅, G) (a constant for fixed q(x, y)), and (2) the diversity metric with

$$\frac{2 λ}{k - 1} ,$$

since there are

$$\frac{k ( k - 1 )}{2}$$

numbers for the difference sum, while only k numbers for the confidence sum.

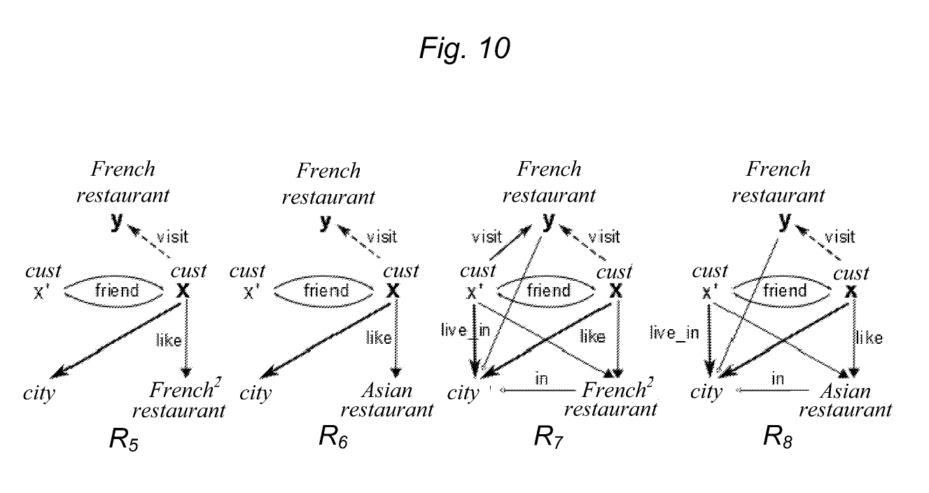

FIG. 8 related to visits to a French restaurant, visits(x, French restaurant). FIG. 10 further adds GPARs R₇ and R₈ pertaining to visits(x, French restaurant). In graphs of FIGS. 8 and 10, (1) supp(q, G₁)=5 (cust₁-cust₄, cust₆), supp(q̅, G₁)=1 (cust₅); (2) R₁(x, G₁)=R₇(x, G₁)={cust₁, cust₂, cust₃}, R₈(x, G₁)={cust₆}; (3) conf(R₁, G₁)=conf(R₇, G₁)=0.6, conf(R₈, G₁)=0.2; and (4) diff(R₁, R₇)=0, diff(R₁, R₈)=diff(R₇, R₈)=1.

For λ=0.5, a top-2 diversified set of these GPARs is {R₇, R₈} with

$$F ( {R}_{7} , {R}_{8} ) = {0.5}^{*} \frac{0.8}{5} + {1}^{*} 1 = 1.08 ( similarly for \{ {R}_{1} , {R}_{8} \} ) .$$

(similarly for {R₁, R₈}). Indeed, R₇ and R₈ find two disjoint customer groups sharing interests in French restaurant and Asian restaurant, respectively, with their friends.

Based on the objective function, the diversified GPAR mining problem (DMP) is stated as follows.

Input: A graph G, a predicate q(x, y), a support bound σ and positive integers k and d.

Output: A set Lₖ of k nontrivial GPARs pertaining to q(x, y) such that (a) F(Lₖ) is maximized; and (b) for each GPAR RεLₖ, supp(R, G)≧σ and r(P_{R}, x)≦d.

DMP is a bi-criteria optimization problem to discover GPARs for a particular event q(x, y) with high support, bounded radius, and balanced confidence and diversity. In practice, users can freely specify q(x, y) of interests, while proper parameters (e.g., support, confidence, diversity) can be estimated from query logs or recommended by domain experts.

The diversified GPAR mining problem is nontrivial. Consider a decision problem to decide whether there exists a set Lₖ of k GPARs with F(Lₖ)≧B for a given bound B. Thus, by reduction from the dispersion problem, the DMP decision problem is NP-hard (Theorem 1).

It is possible to follow a “discover and diversify” approach that (1) first finds all GPARs pertaining to q(x, y) by frequent graph pattern mining, and then (2) selects top-k GPARs via result diversification. However, this is costly: (a) an excessive number of GPARs are generated; and (b) for all GPARs R generated, it has to compute conf(R, G) and their pairwise distances, and moreover, pick a top-k set based on F( ); the latter is an intractable process itself.

It can be done more efficiently, with accuracy guarantees, as set forth in Theorem 2:

Theorem 2: There exists a parallel algorithm for DMP that finds a set Lₖ of top-k diversified GPARs such that (a) Lₖ has approximation ratio 2, and (b) Lₖ is discovered in d rounds by using n processors, and each round takes at most t(|G/n, k, |Σ|) time, where Σ is the set of GPARs R(x, y) such that supp(R, G)≧σ and r(P_{R}, x)≦d.

Here t(|G|/n, k, |Σ| is a function that takes |G|/n, k and |Σ| as parameters, rather than the size |G| of the entire G.

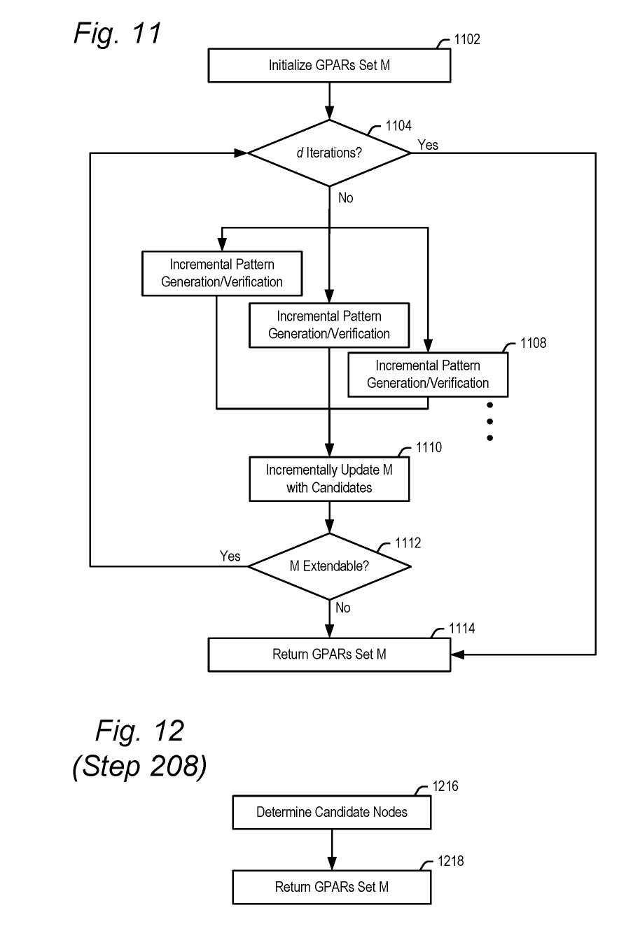

As a proof, an algorithm is provided, denoted as DMine and shown in Table 1 below and described with respect to the flowchart of FIG. 11. It designates one processor as coordinator S_{c} and the rest as workers Sᵢ.

TABLE 1
Algorithm DMine

Algorithm DMine
Input: A graph G, q(x, y), bound σ, and positive integers k and d.
Output: A set Lₖ of top-k diversified GPARs.
/* executed at coordinator */

| | |
|---|---|
| 1. | Lₖ := ; Σ := ; r : = 1; M := {q(x, y)}; |
| 2. | while r ≦ d do |
| 3. | r := r + 1; |
| 4. | post M to all workers and invoke localMine (M) in parallel; |
| 5. | collect in ΔE candidate GPARs in Mᵢ from all workers; |
| 6. | check automorphism and assemble confidence for these GPARs; |
| 7. | ΔE includes R with supp(R, G) ≧ σ; Σ := Σ ∪ ΔE; M := ; |
| 8. | for each GPAR R ε ΔE do |
| 9. | incDiv (Lₖ, R, Σ); /* incrementally update Lₖ, prune Σ, ΔE */ |
| 10. | if R is “extendable” |
| 11. | then M := M ∪ {R}; /* next round */ |
| 12. | return Lₖ; |

/* executed at each worker Sᵢ in parallel, upon receiving M */

| | |
|---|---|
| 13. | Σᵢ := localMine (M); |
| 14. | construct message set Mᵢ from Σᵢ; |
| 15. | send Mᵢ to the coordinator; |

Algorithm DMine works as follows.

(1) It divides G into n−1 fragments (F₁, . . . , Fₙ_{_}₁) such that (a) for each “candidate” vₓ that satisfies the search condition on x in q(x, y), its d-neighbor G_{d}(vₓ), i.e., the subgraph of G induced by N_{d}(vₓ), is in some fragment; and (b) the fragments have roughly even size. These are possible since 98% of real-life patterns have radius 1, 1.8% have radius 2, and the average node degree is 14.3 in social graphs. Thus, G_{d}(vₓ) is typically small compared with fragment size.

Fragment Fᵢ is stored at worker Sᵢ, for iε[1, n−1].

(2) DMine discovers GPARs in parallel by following bulk synchronous processing, in d rounds. The coordinator S_{c} maintains a list Lₖ of diversified top-k GPARs, initially empty. In each round, (a) S_{c} posts a set M of GPARs to all workers, initially q(x, y) only; (b) each worker Sᵢ generates GPARs locally at Fᵢ in parallel, by extending those in M with new edges if possible; (c) these GPARs are collected and assembled by S_{c} in the barrier synchronization phase; moreover, S_{c} incrementally updates Lₖ: it filters GPARs that have low support or cannot make top-k as early as possible, and prepares a set M of GPARs for expansion in the next round.

As opposed to the “discover and diversify” method, DMine combines diversifying into discovering to terminate the expansion of non-promising rules early, rather than to conduct diversifying after discovering; and (b) it incrementally computes top-k diversified matches, rather than recomputing the diversification function F( ) starting from scratch.

Algorithm DMine maintains the following: (a) at the coordinator S_{c}, a set Lₖ to store top k GPARs, and a set Σ to keep track of generated GPARs; and (b) at each worker Sᵢ, a set Cᵢ of candidates vₓ for x at Fᵢ.

In each round, coordinator S_{c} and workers Sᵢ communicate via messages. (1) Each worker Sᵢ generates a set Mᵢ of messages. Each message is a triple <R, conf, flag>, where (a) R is a GPAR generated at Sᵢ, (b) conf includes, e.g., supp(R(x, y), Fᵢ) and supp(Q q̅(x, y), Fᵢ), and (c) a Boolean flag to indicate whether R can be extended at Sᵢ. (2) After receiving Mᵢ, S_{c} generates a set M of messages, which are GPARs to be extended in the next round.

In step 1102, DMine initializes Lₖ and Σ as empty, and M as {q(x, y)} (line 1). For r from 1 to d (step 1104), it improves Lₖ by incorporating GPARs of radius r (lines 2-11), following a levelwise approach. In each round, it invokes localMine with M at all workers (line 4). Details are described below.

Parallel GPARs generation (line 13 of the DMine algorithm, step 1108 of the flowchart of FIG. 11). Additional details of step 1108 are shown in the flowchart of FIG. 12. In the first round (step 1216), procedure localMine receives q(x, y) from S_{c}, and computes the following: (a) three sets: Cᵢ, nodes υₓ that satisfy the search condition of x in discovered GPARs, P_{q}(x, Fᵢ), matches of x in q(x, y), and q̅(x, Fᵢ), nodes υ in Fᵢ that account for supp(q̅, Fᵢ) (described above); and (b) supp(q, Fᵢ)=|Pq(x, Fᵢ)∥, supp(q̅, Fᵢ)=∥P q̅(x, Fᵢ)∥. Note that supp(q, Fᵢ) and supp(q̅, Fᵢ) never change and hence are derived once for all. Each match υₓεq(x, Fᵢ) is referred to as a center node.

In round r, upon receiving M from S_{c}, localMine does the following. For each GPAR R(x, y): Q(x, y) [symbol] q(x, y) in M, and each center node υₓ, it expands Q by including at least one new edge that is at hop r from υₓ, for all such edges.

Message construction (lines 14-15 of the DMine algorithm, step 1218 of FIG. 12). For each GPAR R(x, y): Q(x, y) [symbol] q(x, y), its local confidence conf is computed: (1) supp(R, Fᵢ) and supp(Q, Fᵢ) count nodes in P_{q}(x, Fᵢ) and Cᵢ that match x in R(x, y) and Q(x, y), respectively; and (2) supp(Q q̅, Fᵢ)=|Q(x, Fᵢ)∩P q̅(x, Fᵢ)|. Then conf contains supp(R, Fᵢ), supp(Q q̅, Fᵢ), supp(q, Fᵢ) and supp(q̅ (x, Fᵢ)); where supp(q, Fᵢ) and supp(q̅, Fᵢ) values are from the first round. A Boolean flag is also set to indicate whether R can be extended by checking whether there exists a center node υₓ that has edges at r+1 hops from υx. Message Mᵢ includes <R, conf, flag> for each R, and is sent to S_{c}.

Message assembling (lines 4-7 of the DMine algorithm). Upon receiving Mᵢ from each Sᵢ, coordinator S_{c} does the following. (1) It groups automorphic GPARs from all Mᵢ. (2) For each group of mᵢ=<R, confᵢ, flagᵢ> that refers to the same (automorphic) R, it assembles conf(R) into a single m=<R, conf(R, G), flag>, where (a)

$$conf ( R , G ) = \frac{Σ supp ( R , {F}_{i} ) Σ supp ( \overline{q ,} {F}_{i} )}{Σ supp ( Q \overline{q} , {F}_{i} ) Σ supp ( \overline{q} , {F}_{i} )} ;$$

and (b) flag is the disjunction of all flagᵢ, for ε[1, n−1]. This suffices since by the partitioning of graph G, nodes accounted for local support in Fᵢ are disjoint from those in Eⱼ if i≠j; hence conf(R) can be directly assembled from local conf from Fᵢ. Similarly, supp(R, G)=Σiε[1, n−1] supp(R, Fᵢ). For each GPAR R, if supp(R, G)≧σ, it is added to AΣ and Σ.

Incremental diversification (lines 8-9 of the DMine algorithm). Next, in step 1110, DMine incrementally updates Lₖ by invoking procedure incDiv. It uses a max priority Queue of size

$$⌈ \frac{k}{2} ⌉ ,$$

where (1) each element in Queue is a pair of GPARs, and (2) all GPAR pairs in Queue are pairwise disjoint. In round r, starting from Queue of top-k diversified GPARs with radius at most r−1, DMine improves Queue by incorporating pairs of GPARs from ΔE, with radius r. (1) If Queue contains less than

$$⌈ \frac{k}{2} ⌉$$

GPARs pairs, incDiv iteratively selects two distinct GPARs R and R′ from ΔE that maximize a revised diversification function:

$${F}^{′} ( R , {R}^{′} ) = \frac{1 - λ}{N ( k - 1 )} ( conf ( R ) + conf ( {R}^{′} ) ) + \frac{2 λ}{k - 1} diff ( R , {R}^{′} )$$

and insert (R, R′) into Queue, until

$$\vert Queue \vert = ⌈ \frac{k}{2} ⌉ .$$

It bookkeeps each pair (R, R′) and F′ (R, R′). (2) If

$$\vert Queue \vert = ⌈ \frac{k}{2} ⌉ ,$$

for each new GPAR RεΔE (not in any pair of Queue) and R′εΣ, it incrementally computes and adds a new pair (R, R′)εΔE×Σ that maximizes F′ (R, R′) to Queue. This ensures that a pair (R₁, R₂) with minimum F′(R₁, R₂) is replaced by (R, R′), if F′ (R₁, R₂)<F′ (R, R′).

After all GPAR pairs are processed, incDiv inserts R and R′ into Lₖ, for each GPARs pairs (R, R′)εQueue.

Message generation at S_{c} (lines 10-11 of the DMine algorithm). DMine next selects promising GPARs for further parallel extension at the workers (step 1112). These include RεΔE that satisfy two conditions: (1) supp(R, G)≧σ, since by the anti-monotonic property of support, if supp(R, G)<σ, then any extension of R cannot have support no less than σ; and (2) R is “Extendable”, i.e., flag=true in <R, conf, flag>. It includes such R in M, and posts M to all workers in the next round.

As an example, suppose that graph G₁ in FIG. 8 is distributed to two workers S₁ and S₂, where S₁ contains subgraphs induced by cust₁-cust₃ and their 2-hop neighborhoods in G₁. Let predicate q be visits(x, French restaurant), λ=0.5, d=2 and k=2. Algorithm DMine may be demonstrated using example GPARs R₅-R₈ (FIGS. 8 and 10).

(1) Coordinator S_{c} sends q to all workers, and computes supp(q, G₁)=5 (cust₁-cust₄, cust₆), supp(q̅, G₁)=1 (cust₅).

(2) In round 1, R₅ (among others) is generated at S₁ from 1-hop neighbors of cust₁-cust₃, which are matches in q(x, G₁)(FIG. 6). At S₂, R₅ and R₆ are generated by expanding cust₄ and cust₆. Local messages Mᵢ from Sᵢ include the following:

| site | message | GPAR | R(x, G₁) | Qq̅(x, y) | flag |
|---|---|---|---|---|---|
| S₁ | M₁ | R₅ | cust₁-cust₃ | Ø | T |
| S2 | M₂ | R₅ | cust₄ | cust₅ | T |
| | | R₆ | cust₄-cust₆ | cust₅ | T |
| S_{c} | M | R₅ | cust₁-cust₄ | cust₅ | T |
| | M | R₆ | cust₄-cust₆ | cust₅ | T |

(3) Coordinator S_{c} assembles M₁ and M₂, and builds ΔE including {R₅, R₆}. It computes conf(R₅)=0.8, conf(R₆)=0.4, diff(R₅, R₆)=0.8. It updates Lₖ={R₅, R₆}, with

$${F}^{′} ( {R}_{5} , {R}_{6} ) = {0.5}^{*} \frac{1.2}{5} + {1}^{*} 0.8 = 0.92 .$$

It includes R₅ and R₆ in message M (the table above), and posts it to S₁ and S₂.

(4) In round 2, R₅ is extended to R₇ and R₁ at S₁ and S₂, and R₆ to R₈ at S₂ (FIG. 6); the messages include:

| site | message | GPAR | R(x, G₁) | Qq̅ (x, y) | flag |
|---|---|---|---|---|---|
| S₁ | M₁ | R₇, R₁ | cust₁-cust₃ | Ø | F |
| S2 | M₂ | R₇ | Ø | cust₅ | F |
| | | R₈ | cust₆ | cust₅ | F |

(5) Given these, coordinator S_{c} assembles the messages and computes conf(R₇)=0.6, conf(R₈)=0.2 and diff(R₇, R₈)=1. DMine computes

$${F}^{′} ( {R}_{7} , {R}_{8} ) = {0.5}^{*} \frac{0.8}{5} + {1}^{*} 1 = 1.08 > {F}^{′} ( {R}_{5} , {R}_{6} ) = 0.92 .$$

Hence, it replaces (R₅, R₆) with (R₇, R₈) and updates Lₖ to be {R₇, R₈}. As R₇ and R₈ are marked as “not extendable” at radius 2 (since d=2), DMine returns {R₇, R₈} as top-2 diversified GPARs (step 1114), in total 2 rounds.

By maintaining additional information, DMine reduces the sizes of Σ, M and Mᵢ. The idea is to test whether an upper bound of marginal benefit for any GPAR pairs can improve the minimum F′-value of Lₖ.

In each round r, incDiv filters non-promising GPARs from Σ and ΔE that cannot make top-k even after new GPARs are discovered. It keeps track of (1) a value F′ₘ=min F′ (R₁, R₂) for all pairs (R₁, R₂) in Lₖ, (2) for each GPAR Rⱼ in ΔE, an estimated maximum confidence Uconf+(Rⱼ, G) for all the possible GPARs extended from Rⱼ, and (3) conf(R, G) for each GPAR R in Σ. Here Uconf+(Rⱼ, G) is estimated as follows. (a) Each Sᵢ computes Usuppᵢ(Rⱼ, Fᵢ) as the number of matches of x in Rⱼ(x, Fᵢ) that connect to a center node in Fᵢ at hop r+1 (r≦d−1). (b) Then Uconf⁺(Rⱼ) is assembled at S_{c} as

$$\frac{Σ ⋃ {supp}_{i} ( {R}_{j} , {F}_{i} ) supp ( \overline{q} , G )}{1 * supp ( q , G )} .$$

Denote the maximum Uconf⁺(Rⱼ, G) for RⱼεΔE as max Uconf⁺(ΔE), and the maximum conf(R, G) for RεΣ as max conf(Σ). Then incDiv reduces Σ and M based on the reduction rules below.

Lemma 3 (reduction rules): (1) A GPAR RεΣ cannot contribute Lₖ if

$$\frac{1 - λ}{N ( k - 1 )} ( conf ( R , G ) + max {Uconf}^{+} ( Δ E ) ) + \frac{2 λ}{k - 1} \leq {F}_{m}^{′} .$$

(2) Extending a GPAR RⱼεΔE does not contribute to Lₖ if either (a)Rⱼ is not extendable, or (b)

$$\frac{1 - λ}{N ( k - 1 )} ( U {conf}^{+} ( {R}_{j} , G ) + max conf ( Σ ) ) + \frac{2 λ}{k - 1} \leq {F}_{m}^{′} .$$

For the correctness of the rules, observe the following. (1) For each RεΣ, conf(R)+max Uconf+(ΔE)+1 is an upper bound for its maximum possible increment to the F′-value of Lₖ; similarly for any Rⱼ from ΔE. (2) If GPAR R does not contribute to Lₖ, then any GPARs extended from R do not contribute to Lₖ. Indeed, (a) upper bounds Uconf(R), Usuppᵢ(R), and Uconf⁺(R) are anti-monotonic with any R′ expanded of R, and (b) max Uconf⁺(ΔE) and max conf(Σ) are monotonically decreasing, while F′ₘ is monotonically increasing with the increase of rounds. Hence R can be safely removed from Σ, ΔE or M. Note that the removal of GPARs from Σ benefit the reduction of ΔE with smaller max conf(Σ)), and vice versa. DMine repeatedly applies the rules until no GPARs can be reduced from Σ and ΔE.

To reduce redundant GPARs, DMine checks whether GPARs in ΔE are automorphic at coordinator S_{c} (line 6) and locally at each Sᵢ (localMine). It is costly to conduct pairwise automorphism tests on all GPARs in ΔE, since it is equivalent to graph isomorphism.

To reduce the cost, bisimulation may be used as disclosed in A. Dovier, C. Piazza, and A. Policriti, “A fast bisimulation algorithm,” In CAV, pages 79-90, 2001. A graph pattern P_{R}_{₁} is bisimilar to P_{R}_{₂} if there exists a binary relation O_{b} on nodes of P_{R}_{₁} and P_{R}_{₂} such that (a) for all nodes u₁ in P_{R}_{₁}, there exists a node u₂ in P_{R}_{₂} with the same label such that (u₁, u₂)εO_{b}, and vice versa for all nodes in P_{R}_{₂}; and (b) for all edges (u₁, u′₁) in P_{R}_{₁}, there exists an edge (u₂, u′₂) in P_{R}_{₂} with the same label such that (u′₁, u′₂)εO_{b}; and vice versa for all edges in P_{R}_{₂}. The connection between bisimulation and automorphism is stated as follows.

Lemma 4: If graph pattern P_{R}_{₁} is not bisimilar to P_{R}_{₂}, then R₁ is not an automorphism of R₂.

Hence, for a pair R₁ and R₂ of GPARs, DMine first checks whether P_{R}_{₁} is bisimilar to P_{R}_{₂}. It checks automorphism between R₁ and R₂ only if so. It takes O(|ΔE|²) time to check pairwise bisimilarity O_{b} for all GPARs in ΔE. Moreover, O_{b} can be incrementally maintained when new GPARs are added. These allow efficient (incremental) use of bisimulation tests instead of automorphism tests.

DMine detects trivial GPARs R(x, y): Q(x, y) [symbol] q(x, y) at S_{c} as follows: (1) if supp(q, G) is 0, it returns Ø to indicate that no interesting GPARs exist; and (2) if an extension leads to supp(Qq̅)=0, i.e., no match in Q(x, G) violates q(x, y), S_{c} removes R from ΔE and Σ.

DMine returns a set Lₖ of k diversified GPARs with approximation ratio 2 (line 12), for the following reasons. (1) Parallel generation of GPARs finds all candidate GPARs within radius d. This is due to the data locality of subgraph isomorphism: for any node υₓ in G, υₓεP_{R}(x, G) if and only if υₓεP_{R}(x, G_{d}(υₓ)) for any GPAR R of radius at most d at x. That is, it is determined whether υₓ matches x via R by checking the d-neighbor of υₓ locally at a fragment Fᵢ. (2) Procedure incDiv updates Lₖ following the greedy strategy disclosed in S. Gollapudi and A. Sharma, “An axiomatic approach for result diversification,” In WWW, 2009, with approximation ratio 2. This is verified by approximation-preserving reduction to the max-sum dispersion problem, which maximizes the sum of pairwise distance for a set of data points and has approximation ratio 2. The reduction maps each GPAR to a data point, and sets the distance between two GPARs R and R′ as F′(R, R′).

For time complexity, observe that in each round, the cost consists of (a) local parallel generation time T₁ of candidate GPARs, determined by |Fᵢ|, M and Mᵢ; and (b) total assembling and incremental maintenance cost T₂ of Lₖ at S_{c}, dominated by |Σ|, k and |Mᵢ|. The cost of message reduction (by applying Lemma 3) takes in total O(d|E|) time, where in each round, it takes a linear scan of ΔE and Σ to identify redundant GPARs. Note that Σ_{iε[1,n-1]}|Mᵢ|≦ΔE|, |M|≦|Σ|, and |Fᵢ| is roughly |G|/n by the disclosed partitioning strategy. Hence T₁ and T₂ are functions of |G|/n, k and |Σ| This completes the proof of Theorem 2.

Algorithm DMine can be easily adapted to at least the following two cases. (1) When a set of predicates instead of a single q(x, y) is given, it groups the predicates and iteratively mines GPARs for each distinct q(x, y). (2) When no specific q(x, y) is given, it first collects a set of predicates of interests (e.g., most frequent edges, or with user specified label q), and then mines GPARs for the predicate set as in (1).

The following sections describe how to identify potential customers with GPARs, first describing the Entity Identification Problem. Consider a set Σ of GPARs pertaining to the same q(x, y), i.e., their consequents are the same event q(x, y). The set of entities identified by Σ in a (social) graph G with confidence denoted by Σ(x, G, η), may be defined as follows:

{υx|υxεQ(x,G),Q(x,y) [symbol] q(x,y)εΣ,conf(R,G)≧η} (3)

Under the Entity Identification Problem (EIP):

Input: A set Σ of GPARs pertaining to the same q(x, y), a confidence bound η>0, and a graph G.

Output: Σ(x, G, η).

The EIP is to find potential customers x of y in G identified by at least one GPAR in Σ, with confidence of at least η.

The decision problem of EIP is to determine, given Σ, G and η, whether Σ(x, G, η) #Ø. It is equivalent to decide whether there exists a GPAR RεΣ such that conf(R, G)≧η. The problem is nontrivial, as it embeds the subgraph isomorphism problem, which is NP-hard.

Theorem 5: The decision problem for EIP is NP-hard, even when Σ consists of a single GPAR.

One way to compute Σ(x, G, η) is as follows. For each R(x, y): Q(x, y) [symbol] q(x, y) in Σ, (a) enumerate all matches of Qq̅ and P_{R} in G by using an algorithm for subgraph isomorphism, e.g., VF2 [10]; (b) compute supp(q, G) and supp(q̅, G) once in G; then based on the findings, (c) identify those R with conf(R, G)≧η, and return matches of x by these GPARs. This is cost-prohibitive (e.g., takes O(|G|!|G∥Σ|) time using VF2 (L. P. Cordella, P. Foggia, C. Sansone, and M. Vento, “A (sub) graph isomorphism algorithm for matching large graphs,” TPAMI, 26(10):1367-1372, 2004)) in real-life social graphs G, which often have billions of nodes and edges. It is thus not practical to simply apply graph pattern matching algorithms to EIP over large G. Parallelization may be used to solve the problem. However, parallelization is not always effective.

To characterize the effectiveness of parallelization, parallel scalability may be formalized following C. P. Kruskal, L. Rudolph, and M. Snir, “A complexity theory of efficient parallel algorithms,” TCS, 71(1), 1990. Consider a problem A posed on a graph G. The worst-case running time of a sequential algorithm for solving A on G may be denoted by t(|A|, |F|). For a parallel algorithm, the time taken by the algorithm for solving A on G by using n processors may be denotes by T(|A|, |G|, n). Here, it is assumed that n<<|F|, i.e., the number of processors does not exceed the size of the graph; this typically holds in practice since G has billions of nodes and edges, much larger than n.

The algorithm is said to be parallel scalable if

T(|A|,|G|,n)=O(t(|A|,|G|)/n)+(n|A|)^{O(1)} (4)

That is, the parallel algorithm achieves a polynomial reduction in sequential running time, plus a “bookkeeping” cost O((n|A|^{l}) for a constant l that is independent of |G|.

If the algorithm is parallel scalable, then for a given G, it guarantees that the more processors are used, the less time it takes to solve A on G. It allows big graphs to be processed by adding processors when needed. If an algorithm is not parallel scalable, there may not be a reasonable response time no matter how many processors are used. Problem A is said to be parallel scalable if there exists a parallel scalable algorithm for it.

Theorem 6: EIP is parallel scalable. As a proof, a parallel algorithm may be outlined for EIP, denoted by Match_{c}. Given Σ, G=(V, E, L), η and a positive integer n, it computes Σ(x, G, η) by using n processors. Note that Match_{c} is exact: it computes precisely Σ(x, G, η).

To present Match_{c}, the following notations may be used. (a) d is used to denote the maximum radius of R(x, y) at node x, for all GPARs R in Σ. (b) For a node υₓεV, G_{d}(υₓ) is the d-neighbor of υₓ in G (described above). (c) the set of all candidates υₓ of x, i.e., nodes in G that satisfy the search condition of x in q(x, y) are denoted by L.

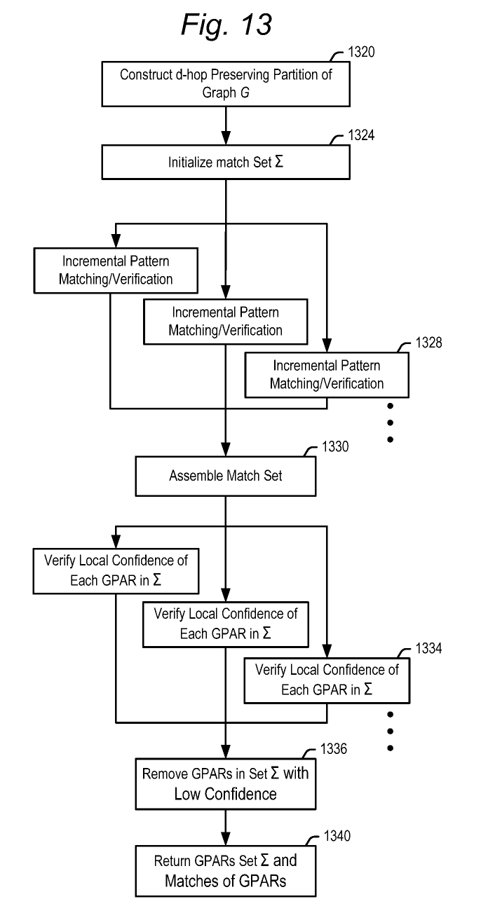

Match_{c} capitalizes on the data locality of subgraph isomorphism (as discussed above). The Match_{c} algorithm will now be described with reference to the flowchart of FIG. 13.

(1) Partitioning. It divides G into n fragments [symbol] =(F₁, . . . , Fₙ) (step 1320) in the same way as algorithm DMine (described above), such that Ft's have roughly even size, and G_{d}(υₓ) is contained in one Fᵢ for each υₓεL. This is done in parallel. In particular, G_{d}(υₓ) can be constructed in parallel by revising BFS (breadth-first search), within d hops from υₓ. The match set Σ is initialized (step 1324), and each fragment Fᵢ is assigned to a processor Sᵢ for iε[1, n].

(2) Matching. All processors Sᵢ compute local matches in Fᵢ in parallel (step 1328). For each candidate υₓεL that resides in Fᵢ, and for each GPAR R(x, y): Q(x, y) [symbol] q(x, y) in Σ, Sᵢ checks whether υₓ is in P_{R}(x, G_{d}(υₓ)), P_{q}(x, G_{d}(υₓ)) and P_{q}(x, G_{d}(υₓ)), and whether υₓ has an outlink labeled q.

(3) Assembling. Compute conf(R, G) for each R in Σ by assembling the partial results of (2) above (step 1330). This is also done in parallel: first partition L into n fragments; then each processor operates on a fragment and computes partial support (step 1334). These partial results are then collected to compute conf(R, G). In step 1336, for any υₓ not having a GPAR R such that υₓεP_{R}(x, G) and conf(R, G)≧η, these are removed. Finally, step 1340 outputs those υₓ when there exists a GPAR R such that υₓεP_{R}(x, G) and conf(R, G)≧η.

To show that Match_{c} is parallel scalable, the following is noted. (1) Step 1 is in O(|L∥G_{d}^{m}|/n) time, since BFS is in O(|G_{d}^{m}|) time, where G_{d}^{m} is the largest d-neighbor for all υₓεL. (2) Step 2 takes O(t(G_{d}^{m}|, |Σ|)|L|/b) time, where t(|G_{d}^{m}|, |Σ|) is the worst-case sequential time for processing a candidate υₓ. (3) Step 3 takes O(|L∥Σ|/n) time. (4) By |L|≦|V|, steps 1 and 2 take much less time than t(|G|, |Σ|), since t(,) is an exponential function by Theorem 5, unless P=NP. (5) In practice, t(|G_{d}^{m}|, |Σ|)|L|<<t(|G|, |Σ|) since t(,) is exponential and G_{d}^{m} is much smaller than G. Indeed, (a) in the real world, graph patterns in GPARs are typically small, and hence so is the radius d; as discussed above, G_{d}(υₓ) is thus often small. Putting these together, the parallel cost T(|G|, |Σ|, n)<O(t(|G|, |Σ|)/n), and better still, the larger n is, the smaller T(|G|, |Σ|, n) is.

Algorithm DMine (discussed above) takes t(|A|/n, k) time and is parallel scalable if the problem size |A| is measured as |G|+|Q|+|Σ| [29]. Indeed, if one wants all candidate GPARs R with supp(R, G)≧σ, then |Σ| is the size of the output, and |Σ| is not large (due to small d and large σ).

Certain optimization strategies may be employed to optimize Match_{c}. Algorithm Match_{c} just aims to show the parallel scalability of EIP. Its cost is dominated by step 2 for matching via subgraph isomorphism. To reduce the cost, algorithm Match may be developed that improves Match_{c} by incorporating the following optimization techniques. To simplify the discussion, a single GPAR R(x, y): Q(x, y) [symbol] q(x, y) may be taken as the starting point.

For each candidate υₓεL that resides in fragment Fᵢ, a check is performed to determine whether there exists a match Gₓ of P_{R} in which υₓ matches x. When one Gₓ is verified as a match of P_{R}, υₓ is included in P_{R}(x, Fᵢ), without enumerating all matches of P_{R} at υₓ, and the process may be terminated. This is done locally at Fᵢ: by the partitioning strategy, G_{d}(υₓ) is contained in Fᵢ.

To identify Gₓ at υₓ, Match starts with pair (x, υₓ) as a partial match m, and iteratively grows m with new pairs (u, v) for uεP_{R} and υΣG_{d}(υₓ) in a guided search until a complete match is identified, i.e., m covers all the nodes in P_{R}. A complete m induces a subgraph Gₓ. It is in PTIME to verify whether m is an isomorphism from P_{R} to Gₓ.

To grow m, Match performs guided search based on k-hop neighborhood sketch. For each node υ in G, a k-hop sketch K(υ) is a list {(1, D₁), . . . , (k, Dₖ)}, where Dᵢ denotes the distribution of the node labels and their frequency at i hop of υ. Given a pair (u, v) newly added to m and a pattern edge (u, u′) in Q, Match picks “the best neighbor” υ′ of υ such that the pair (u′, υ′) has a high possibility to make a match. This is decided by assigning a score ƒ(u′, υ′) as E_{iε[1,k]}(Dᵢ−D′ᵢ), where D′ᵢεK(u′), DᵢεK(υ′), and Dᵢ−D′ᵢ is the total frequency difference for each label in Dᵢ. In fact, (1) υ′ does not match u′ if for some i, Dᵢ−D′ᵢ; and (2) the larger the difference is, the more likely υ′ matches u′. If (u′, υ′) does not lead to a complete m, Match backtracks and picks υ″ with the next best score r(u′, υ″).

As an example, referring to GPAR R₁ of FIG. 4, for its designated node x, the 2-hop neighborhood sketch L₂(x) in P_{R1} contains pair (1, D₁={(city, 1), (cust, 1), (French Restaurant, 4)}) and (2, D₂={(city, 1), (cust, 1), (French Restaurant, 4)}).

Given R₁ and G₁ of FIGS. 4 and 8, Match identifies P_{R}_{₁} (x, G₁) as follows. (1) It finds P_{q1} (x, G)={cust₁-cust₄, cust₆}, while cust₅ accounts for supp(q̅₁, G₁). (2) It computes P_{R}_{₁} (x, by verifying candidates υₓ from P_{q}(x, G₁), and calculates ƒ(x, υₓ) in G₁, e.g., L₂(cust₂)={(1, D₁={(city, 1), (cust, 2), (French Restaurant, 8)}), (2, D₂={(city, 1), (cust, 2), (French Restaurant, 8)})}. Hence ƒ (x, cust₂)=5+5=10. Match then ranks candidates cust₂, cust₁, cust₃, cust₄, where cust₆ is filtered due to mismatched sketches. (2) At cust₂, Match starts from (x, cust₂), and extends to (x′, cust₃) since ƒ (x′, cust₃) is the highest. It continues to add pairs (city, New York), (French Restaurant, LeBernardin) and three pairs for French Restaurant₃. This completes the match, and cust₂ is verified a match. (3) Similarly, Match verifies cust₁ and cust₃, and finds P_{R}_{₁} (x, G₁)={cust₁, cust₂, cust₃}.

Given P_{R}_{₁} (x, G₁), Match only needs to verify cust₅ for Q₁ in R₁; it finds Q₁(x, G₁)=P_{R}_{₁} (x, G₁)∪{cust₅}. It also finds supp(q, G₁)=5 (cust₁-cust₄, cust₆), supp(q̅, G₁)=1 (cust₅), and computes

$$conf ( {R}_{1} ) = \frac{3 * 1}{1 * 5} = 0.6 .$$

Given a set Σ of GPARs, Match revises step (2) of Match_{c} by checking whether υₓ matches x via guided search and early termination; it reduces redundant computation for multiple GPARs by extracting common sub-patterns of GPARs in Σ. It remains parallel scalable following the same complexity analysis for Match_{c}.

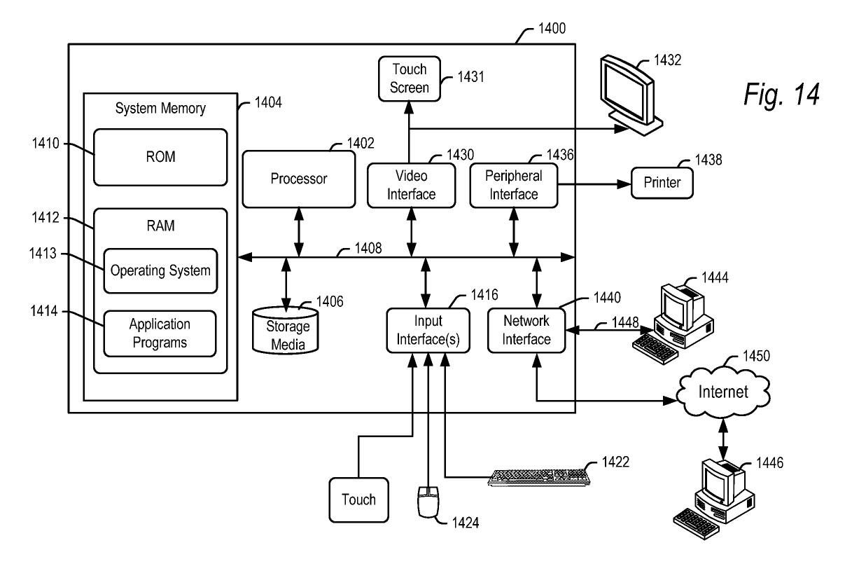

FIG. 14 is a block diagram of a computing environment 1400 for executing embodiments of the present technology. Components of computing environment 1400 may include, but are not limited to, a processor 1402, a system memory 1404, computer readable storage media 1406, various system interfaces 1416, 1430, 1431, 1436, 1440 and a system bus 1408 that couples various system components. The system bus 1408 may be any of several types of bus structures including a memory bus or memory controller, a peripheral bus, and a local bus using any of a variety of bus architectures.

The computing environment 1400 may include computer readable media. Computer readable media can be any available tangible media that can be accessed by the computing environment 1400 and includes both volatile and nonvolatile media, removable and non-removable media. Computer readable media does not include transitory, modulated or other transmitted data signals that are not contained in a tangible media. The system memory 1404 includes computer readable media in the form of volatile and/or nonvolatile memory such as ROM 1410 and RAM 1412. RAM 1412 may contain an operating system 1413 for the computing environment 1400. RAM 1412 may also execute one or more application programs 1414. The computer readable media may also include storage media 1406, such as hard drives, optical drives and flash drives.

The computing environment 1400 may include a variety of interfaces for the input and output of data and information. Input interface 1416 may receive data from different sources including touch (in the case of a touch sensitive screen), a mouse 1424 and/or keyboard 1422. A video interface 1430 may be provided for interfacing with a touchscreen 1431 and/or monitor 1432. A peripheral interface 1436 may be provided for supporting peripheral devices, including for example a printer 1438.

The computing environment 1400 may operate in a networked environment via a network interface 1440 using logical connections to one or more remote computers 1444, 1446. The logical connection to computer 1444 may be a local area connection (LAN) 1448, and the logical connection to computer 1446 may be via the Internet 1450. Other types of networked connections are possible, including broadband communications as described above. It is understood that the above description of computing environment 1400 is by way of example only, and may include a wide variety of other components in addition to or instead of those described above.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of identifying graph pattern association rules having a confidence above a predetermined confidence threshold in a social network, the graph including a plurality of designated nodes and a plurality of association edges between the designated nodes, comprising:
identifying a first data element that corresponds to a first node of interest;
identifying at least a second data element that is a common data element to the first node of interest and to a second node of interest;
identifying a first subgraph including the first node of interest and a second subgraph including the second node of interest, wherein the first and second subgraphs include the at least second data element identifying relationships among the first and the second nodes of interest, wherein the first and second subgraphs specify conditions as topological constraints represented by one or more edges formed from the relationships among the first and second nodes of interest;
determining one or more graph pattern association rules (GPARs) for the first and second subgraphs; and
using the first and second nodes of interest and the GPARs to identify one or more consequents among the second node of interest and the data elements.

2. The method of claim 1, wherein the one or more consequents include a consequent between the second node of interest and the first data element.

3. The method of claim 1, wherein the step of determining one or more GPARs comprises determining top diversified graph pattern association rules, where the top diversified graph pattern association rules comprise the graph pattern association rules determined to have a confidence level above a predetermined confidence threshold.

4. The method of claim 3, wherein the confidence level is based in part on the number of pattern matching isomorphic subgraph association edges for the two or more designated nodes.

5. The method of claim 1, further comprising removing graph pattern association rules which do not have a confidence level above the predetermined confidence threshold.

6. A method of parallel mining a set M of graph pattern association rules in a graph of a social network, the graph including a plurality of nodes and a plurality of association edges between nodes, the method comprising:
dividing the graph into a plurality of fragments F;
using a plurality of processors comprising a coordinator processor and a plurality of worker processors, processing each fragment F in parallel in each of the plurality of worker processors to identify candidate graph pattern association rules for the set M, a candidate graph pattern association rule, R(x, y), being defined as Q(x, y) [symbol] q(x, y), where Q(x, y) is a graph pattern in which x and y are two designated nodes, and q(x, y) is an edge labeled q from x to y, on which the same search conditions as in Q are imposed;
verifying candidate graph pattern association rules as having at least a predefined confidence threshold; and
transmitting the verified candidate graph pattern association rules to the coordinator processor to update the set M.

7. The method of claim 6, further comprising re-transmitting the set M of graph pattern association rules to the worker processors, the worker processors determining whether the set M may be extended by adding additional graph pattern association rules in each worker processor by finding additional edges q(xᵢ, yᵢ), where q(xᵢ, yᵢ) is an association edge of the fragment labeled q from xᵢ to yᵢ, and where xᵢ and yᵢ have one or more additional neighboring nodes in common.

8. The method of claim 7, wherein said determining whether the set M may be extended comprises setting a Boolean flag by checking whether there exists a center node υx that has edges at r+1 hops from υx.

9. The method of claim 6, wherein processing the each fragment F in the plurality of worker processors to identify candidate graph pattern association rules comprises:
determining nodes υₓ that satisfy a search condition of x in the set M of graph pattern association rules;
determining matches of x in q(x, y); and
determining nodes υ in Fᵢ that account for supp(q̅, Fᵢ).

10. The method of claim 9, wherein each graph pattern association rule is given by R(x, y): Q(x, y) [symbol] q(x, y) in set M, (c) of verifying candidate graph pattern association rules comprises the computing local confidence supp(R, Fᵢ) and supp(Q, Fᵢ) by:
counting nodes in P_{q}(x, Fᵢ) and Cᵢ that match x in R(x, y) and Q(x, y), respectively; and
setting supp(Q q̅, Fᵢ)=∥Q(x, Fᵢ)∩P q̅ (x, Fᵢ)∥.

11. The method of claim 6, further comprising reducing redundant graph pattern association rules after the set M of graph pattern association rules have been updated in the coordinator processor by checking whether any graph pattern association rules are automorphic.

12. The method of claim 11, further comprising using bisimulation when checking whether any graph pattern association rules are automorphic.

13. The method of claim 6, further comprising reducing redundant graph pattern association rules after the set M of graph pattern association rules have been updated in the coordinator processor by checking whether any graph pattern association rules are automorphic.

14. A system for parallel mining a graph of a social network, the system comprising:
a plurality of processors, the plurality of processors comprising a coordinator processor and a plurality of worker processors, the plurality of processors configured to:
identify a first data element that corresponds to a first node of interest;
identify at least a second data element that is a common data element to the first node of interest and to a second node of interest;
identify a first subgraph including the first node of interest and a second subgraph including the second node of interest, wherein the first and second subgraphs include the at least second data element identifying relationships among the first and the second nodes of interest, wherein the first and second subgraphs specify conditions as topological constraints represented by one or more edges formed from the relationships among the first and second nodes of interest;
determine one or more graph pattern association rules (GPARs) for the first and second subgraphs, with a GPAR being defined as Q(x, y) [symbol] q(x, y), where Q(x, y) is a graph pattern in which x and y are two designated nodes and q(x, y) is an edge labeled q from x to y, on which the same search conditions as in Q are imposed; and
use the first and second nodes of interest and the GPARs to identify one or more consequents among the second node of interest and the data elements.

15. The system of claim 14, further comprising the step of processing each fragment Fᵢ in parallel in each of the plurality of worker processors Sᵢ to identify local matches in Fᵢ.

16. The system of claim 15, wherein the step of processing each fragment Fᵢ in parallel in each of the plurality of worker processors Sᵢ to identify local matches in Fᵢ comprises checking whether υₓ has an out link labeled q for each candidate υₓεL that resides in Fᵢ, and for each graph pattern association rule, where q is the consequent of a graph pattern association rule.

17. A non-transitory computer-readable medium storing computer instructions for identifying a set M of graph pattern association rules in a graph of a social network, with the computer instructions executed by one or more processors to perform the steps of:
identifying a first data element that corresponds to a first node of interest;
identifying at least a second data element that is a common data element to the first node of interest and to a second node of interest;
identifying a first subgraph including the first node of interest and a second subgraph including the second node of interest, wherein the first and second subgraphs include the at least second data element identifying relationships among the first and the second nodes of interest, wherein the first and second subgraphs specify conditions as topological constraints represented by one or more edges formed from the relationships among the first and second nodes of interest;
determining one or more graph pattern association rules (GPARs) for the first and second subgraphs; and
using the first and second nodes of interest and the GPARs to identify one or more consequents among the second node of interest and the data elements, wherein the one or more consequents include a consequent between the second node of interest and the first data element.

18. The non-transitory computer readable medium of claim 16, further comprising determining whether the set M may be extended by adding additional graph pattern association rules in each worker processor by finding additional edges q(xᵢ, yᵢ), where q(xᵢ, yᵢ) is an association edge of the fragment labeled q from xᵢ to yᵢ, and where xᵢ and yᵢ have one or more additional neighboring nodes in common.

19. The non-transitory computer readable medium of claim 18, wherein determining whether the set M may be extended comprises setting a Boolean flag by checking whether there exists a center node υx that has edges at r+1 hops from υx.

20. The non-transitory computer readable medium of claim 17, wherein the step of determining GPARs comprises:
determining nodes υₓ that satisfy a search condition of x in the set M of graph pattern association rules;
determining matches of x in q(x, y); and
determining nodes υ in Fᵢ that account for supp(q̅, Fᵢ).
